(19) United States
(12) Patent Application Publication
(10) Pub. No.: US 2006/0023687 A1
(43) Pub. Date: Feb. 2, 2006

(54) Fast reliable downlink signaling to support enhanced uplink services in a communication system

(75) Inventors: Jung-Fu Thomas Cheng, Cary, NC (US); Yi-Pin Eric Wang, Cary, NC (US)

Correspondence Address: ERICSSON INC., 6300 LEGACY DRIVE, M/S EVR C11, PLANO, TX, 75024, US

(73) Assignee: Telefonaktiebolaget LM Ericsson (publ), Stockholm (SE)

(21) Appl. No.: 10/900,241

(22) Filed: Jul. 27, 2004

(51) Int. Cl. H04B 7/216

(52) U.S. Cl. 370/342

(57) ABSTRACT

A method, system, and apparatus for transferring new information on a dedicated physical channel (DPCH) from a base station to a user equipment (UE) terminal in a radio telecommunication system. A downlink signal containing the information, such as an ACK/NACK signal, is bit-level spread across one or more time slots utilizing a spreading sequence having good auto-correlation and cross-correlation properties with the DPCH. The spread downlink signal is then combined with a DPCH signal to form a combined signal, and the combined signal is spread utilizing a channelization code already assigned to the DPCH. The spread, combined signal is then transmitted to the UE terminal, which separately decodes the downlink signal to extract the information. The UE terminal then determines effects that the downlink signal had on the received DPCH signal, and subtracts the contribution of the downlink signal from the DPCH signal prior to decoding the DPCH signal.

### BACKGROUND

The present invention relates to communication systems. More particularly, and not by way of limitation, the present invention is directed to a method, system, and apparatus for providing fast reliable downlink signaling to support enhancements for uplink dedicated transport channels in a radio telecommunication system.

In a cellular radio telecommunication system such as a Wideband Code Division Multiple Access (WCDMA) system, data frames or packets are encoded and transmitted from a Node B in the system to a user equipment (UE) terminal such as a mobile station on a downlink channel. The UE transmits encoded data frames or packets to the Node B on an uplink channel. At the receiving end, the data frames or packets are decoded to recover the transmitted encoded block of information.

In the evolution of both WCDMA and CDMA2000, there is interest in enhancing uplink dedicated transport channels to reduce air-interface delays, improve system capacity, and increase cell coverage of high bit-rate services. These goals can generally be achieved through the use of the Hybrid Auto-Retransmission Request (HARQ) protocol and the Fast Rate Control protocol on the uplink transport channels. With the introduction of these two protocols, new fast reliable downlink control signaling is required. To avoid excessive consumption of system radio resource, it is desirable to design these new control signaling channels with coding efficiency and power efficiency in mind.

To enable smooth operation of these two protocols, controlling network entities need to establish reliable downlink control signaling communications with the UE in service. The downlink control signaling communications from the Node B to the UE may include, but are not limited to an ACK/NACK (acknowledgement or no acknowledgment) of the packet sent by the UE in the enhanced uplink channel, instructions to increase or decrease the highest allowable data rate for the enhanced uplink channel, and specific instructions to stop or resume the enhanced uplink.

The amount of information in these messages is not significant, so for this sort of communication, it would be wasteful and sometimes impossible to allocate separate channelization code resources to each UE having an enhanced uplink. General consensus in the industry is to try to either piggyback the information on an existing code channel already allocated to the UE, or pool information from several UEs on a new shared code channel, either through time division or code division multiplexing. Currently, there are three competing channel structure proposals to support downlink signaling for enhanced uplink services. Designs based on these approaches have different advantages and disadvantages, which are discussed in more detail below.

FIG. 1 is a simplified block diagram of an existing technique for downlink signaling in which required downlink information is piggybacked on a Dedicated Physical Channel (DPCH) utilizing Time-Division Multiplexing (TDM). In this solution, certain bits 11-12 from the DPCH 13, which consists of a Dedicated Physical Data Channel (DPDCH) and a Dedicated Physical Control Channel (DPCCH), are punctured to create space for carrying the desired downlink signals 14-15. The new downlink signals are added at 16 and spread at 17 using the existing channelization code of the DPCH. This approach is described in greater detail in the document, 3GPP TSG-RAN WG1 Input Document Tdoc R1-03-0734, “Downlink Structure—Time Multiplexed Solution,” Nokia Inc., which is incorporated herein by reference. There are two main advantages of the TDM-on-DPCH approach. First, the new downlink signals do not consume additional channel spreading code resources. Second, the UE is not required to demodulate an additional code channel in order to receive the downlink signaling. This allows even low-end terminals, which typically have limited multicode reception capability, to support enhanced UL services. To mitigate the impact on the existing DPDCH, only a very small portion of the DPDCH slot (or frame) is punctured to create the time intervals available for transmitting the new downlink signal. A resulting disadvantage is that the short transmission interval results in a high peak power requirement in order to ensure good reception quality for the newly added downlink signaling channel. Under certain channel conditions, this peak power requirement cannot be supported. An additional disadvantage of this approach is that performance of the DPDCH is degraded since the coding gain is reduced due to the puncturing process.

FIG. 2 is a simplified block diagram of an existing technique for downlink signaling in which TDM is utilized on a shared physical channel. In this solution, a new physical code channel 21 is shared among Users 1-K who require the new downlink signaling by assigning the users to different time slots 22-24 of the new shared physical channel. The multiple signaling channels (time slots) are combined at 25 and then spread at 26 using a new common channelization code. The new code channel 21 is transmitted together with a DPCH signal 27-28 for each of Users 1-K. This approach is described in greater detail in the document, 3GPP TSG-RAN WG1 Input Document Tdoc R1-03-1010, “Simulation Results of ACKCH with TDM Structure,” Qualcomm Inc., which is incorporated herein by reference. The general advantage of using a new physical code channel is that modifications to the existing DPDCH, together with the corresponding performance degradation, are avoided. However, the approach has the disadvantage that the UEs are required to demodulate an additional code channel to receive the new downlink signals. During a soft handover, this problem is further exacerbated because the UE is required to receive multiple shared physical code channels from multiple Node Bs. Additionally, like the TDM-on-DPDCH approach of FIG. 1, the shared-channel-TDM approach also requires a high peak power during the short transmission interval for the downlink signals in order to ensure good reception quality. Thus, this approach suffers a similar peak-power problem when the new physical code channel is shared in a TDM fashion among the users.

FIG. 3 is a simplified block diagram of an existing technique for downlink signaling in which Code-Division Multiplexing (CDM) is utilized on a shared physical channel. In this solution, a new physical code channel 31 is shared among Users 1-K who require the new downlink signaling by assigning the users different bit-level spreading sequences 32-33 to carry separate downlink signals 34-35, respectively. The signal for each user is spread utilizing the user-unique bit-level (or symbol-level) spreading sequence at 36-37, and the signals are then multiplexed at 38 onto the new common channel. The new common channel is then spread at 39 using a new common channelization code. As in the shared-channel-TDM approach of FIG. 2, the new code channel 31 is transmitted together with a DPCH signal 27-28 for each of Users 1-K. This approach is described in greater detail in the document, 3GPP TSG-RAN WG1 Input Document Tdoc R1-03-0670, “Impact of DL Support Channels on E-DPDCH,” Qualcomm Inc., which is incorporated herein by reference.

To detect the downlink signal, a UE first de-spreads the received signal using a common, shared, channelization code. After de-spreading, the de-spread values are correlated with the user-specific bit-level sequence to extract the user-specific signal. Once again, the general advantage of using a new physical code channel is that modifications to the existing DPDCH, together with the corresponding performance degradation, are avoided. Additionally, the peak power problem experienced with TDM approaches is largely overcome when the new physical channel is spread over a long time interval. The major problem of the shared-channel-CDM approach is the near-far problem in dispersive channels. Although the bit-level spreading sequences are mutually orthogonal, orthogonality cannot be preserved when the radio channel is time-varying, for example, in high Doppler conditions. In order to guarantee a certain reception quality for any given user, the signaling channel is power-controlled, resulting in a difference of as much as 20 dB between the transmit power of signaling messages addressed to different users. This means that a signal transmitted with a much higher power can severely interfere with the detection of signals transmitted with much lower power when orthogonality is lost due to time-varying fading.

It would be advantageous to have a method, system, and apparatus for providing fast reliable downlink signaling to support enhancements for uplink dedicated transport channels that overcomes the disadvantages of existing methods while also providing significant gains in performance. The present invention provides such a method, system, and apparatus.

### SUMMARY

In one aspect, the present invention is directed to a method of transmitting a new downlink signal from a base station to a user equipment (UE) terminal in a radio telecommunication system. The new downlink signal may be used to transfer the new control signaling needed for supporting HARQ and rate-control operations. The method includes the steps of spreading the downlink signal across at least one time slot; combining the spread downlink signal with a dedicated physical channel (DPCH) signal to form a combined signal; spreading the combined signal; and transmitting the spread combined signal to the UE terminal. The downlink signal may be spread utilizing a spreading sequence having good cross-correlation properties with the DPCH signal, and the combined signal may be spread utilizing the channelization code of the DPCH. In addition, the spread downlink signal may be placed in relation to the DPCH signal such that the downlink signal does not overlap important bits in the DPCH signal such as the transmit power command (TPC) bits or pilot sequence bits.

In another aspect, the present invention is directed to a method of transferring new information from a base station to a UE terminal on a channelization code already used on a DPCH from the same base station to the same UE terminal. The method includes the steps of spreading a new downlink signal containing the new information across at least one time slot; combining the spread downlink signal with a DPCH signal to form a combined signal; spreading the combined signal utilizing the channelization code of the DPCH; and transmitting the spread combined signal to the UE terminal. The method also includes separately decoding the new downlink signal by the UE terminal to extract the information; determining effects that the new downlink signal had on the received DPCH signal; subtracting the effects of the new downlink signal from the DPCH signal; and decoding the DPCH signal.

In yet another aspect, the present invention is directed to a system in a radio telecommunication network for transferring new information on a channelization code already assigned to a DPCH from a base station to a UE terminal. The system includes means within the base station for spreading a new downlink signal containing the new information across at least one time slot; multiplexing means within the base station for combining the spread downlink signal with a DPCH signal to form a combined signal; means within the base station for spreading the combined signal utilizing a channelization code of the DPCH; and transmission means within the base station for transmitting the spread combined signal to the UE terminal. The system also includes means within the UE terminal for receiving the spread combined signal; means within the UE terminal for separately decoding the new downlink signal to extract the information; means within the UE terminal for determining effects that the new downlink signal had on the received DPCH signal, and for subtracting the effects of the new downlink signal from the DPCH signal; and means within the UE terminal for decoding the DPCH signal.

In still yet another aspect, the present invention is directed to an apparatus in a base station in a radio telecommunication network for transferring information on a channelization code already assigned to a DPCH from a base station to a UE terminal. The apparatus includes means for spreading a new downlink signal containing the new information across at least one time slot; multiplexing means for combining the spread downlink signal with a DPCH signal to form a combined signal; means for spreading the combined signal utilizing a channelization code of the DPCH; and transmission means for transmitting the spread combined signal to the UE terminal.

In still yet another aspect, the present invention is directed to an apparatus in a UE terminal in a radio telecommunication network for receiving and decoding information contained in a new downlink signal transmitted on channelization code already allocated to a DPCH from a base station. The apparatus includes means for receiving a spread combined signal transmitted from the base station on the DPCH channelization code, wherein the combined signal includes the new downlink signal combined with a DPCH signal; means for separately decoding the new downlink signal to extract the information; means for determining effects that the new downlink signal had on the received DPCH signal, and for subtracting the effects of the new downlink signal from the DPCH signal; and means for decoding the DPCH signal.

### BRIEF DESCRIPTION OF THE SEVERAL VIEWS OF THE DRAWINGS

In the following section, the invention will be described with reference to exemplary embodiments illustrated in the figures, in which:

FIG. 1 (Prior Art) is a simplified block diagram of an existing Dedicated Physical Channel (DPCH) on which required downlink information is piggybacked using Time-Division Multiplexing (TDM);

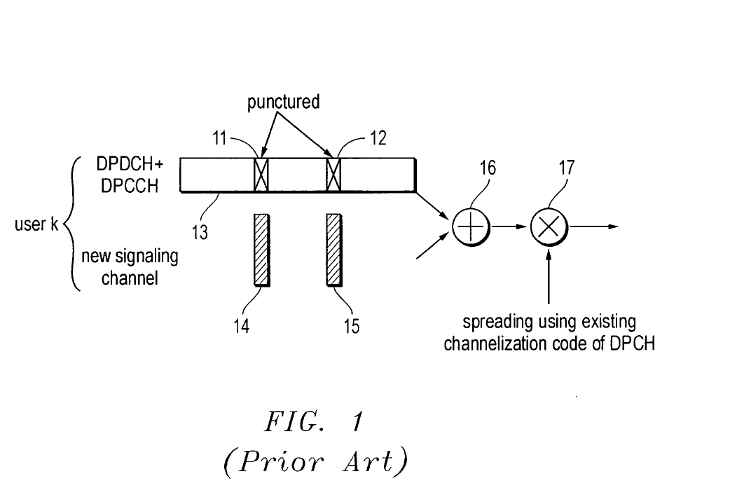

FIG. 2 (Prior Art) is a simplified block diagram of an existing technique for transferring downlink information in which Time-Division Multiplexing (TDM) is utilized to address a plurality of UE terminals on a shared physical channel;

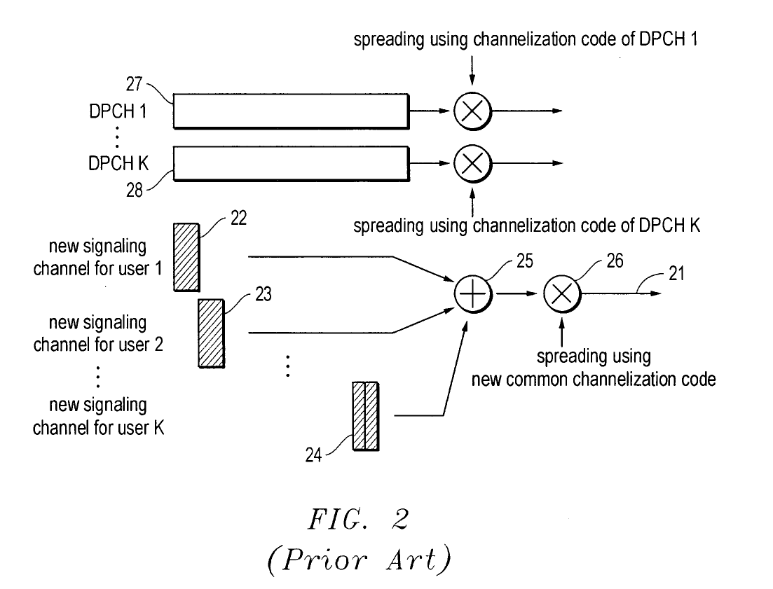

FIG. 3 (Prior Art) is a simplified block diagram of an existing technique for transferring downlink information in which Code-Division Multiplexing (CDM) is utilized to address a plurality of UE terminals on a shared physical channel;

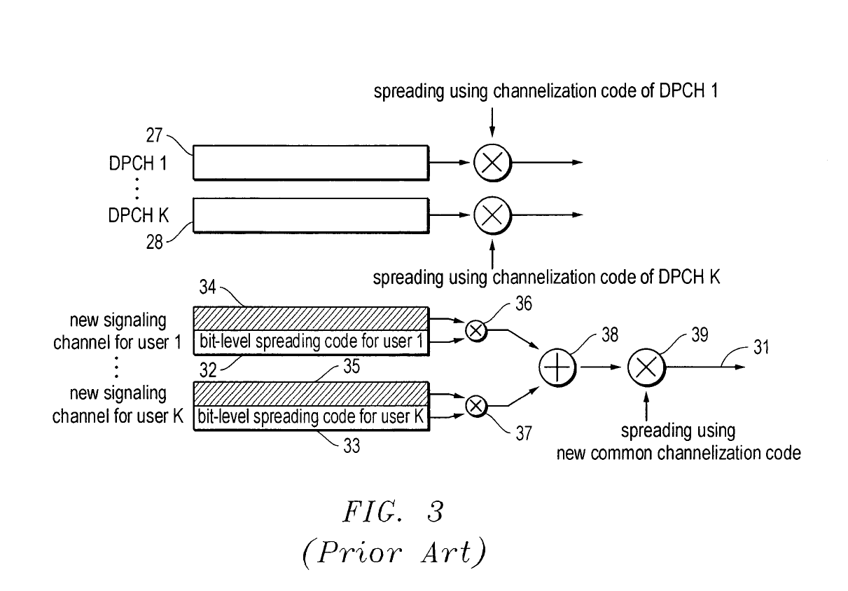

FIG. 4 is a simplified block diagram illustrating an embodiment of the present invention in which CDM is utilized on a channelization code already assigned to a DPCH to transfer new downlink information to a UE terminal, with interference subtraction in the target UE;

FIG. 5 is an illustration of a slot format showing a generic bit sequence format for a general downlink DPCH and a new downlink signal, which utilizes a spreading sequence with good correlation properties with the existing DPCH to transfer new downlink information; and

FIG. 6 is a flow chart illustrating the steps of the preferred embodiment of the method of the present invention.

### DETAILED DESCRIPTION

In accordance with the teachings of the present invention, an improved method and apparatus provides fast reliable downlink control signaling to support enhancements for uplink dedicated transport channels in a radio telecommunication system. The inventive method, which may be referred to as “CDM-on-DPDCH with interference subtraction,” substantially provides the advantages of prior art approaches while avoiding the disadvantages.

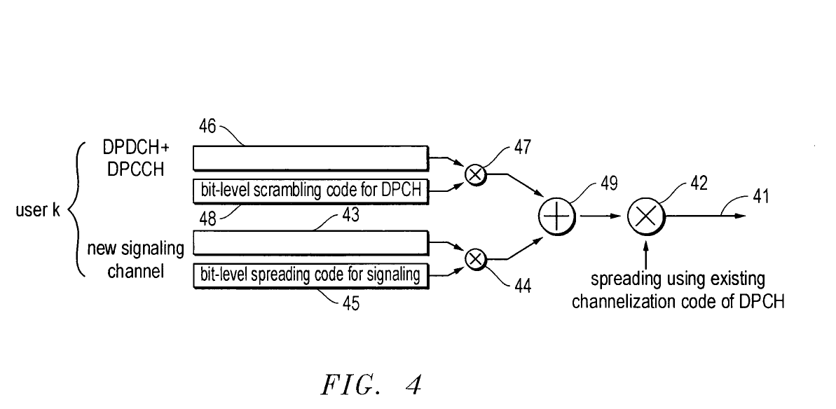

FIG. 4 is a simplified block diagram illustrating an embodiment of the present invention in which Code-Division Multiplexing (CDM) is utilized on a channelization code already assigned to the DPCH, with interference subtraction in the target UE. The new downlink signal 43 is carried by the existing channelization code 42 for the existing downlink DPCH. Therefore, no additional channelization code resources need to be allocated, and the target UE is not required to demodulate additional codes. The new control signaling channel 43 is first spread at 44 by a sequence 45 having good cross-correlation (and preferably auto-correlation) properties. The spreading sequence 45 has a bit rate equal to the bit rate of the DPCH; therefore, this process is referred to as bit-level spreading. The DPCH 46 may be optionally bit-level scrambled at 47 using the bit-level scrambling code 48 for the DPCH. The spread signal is optionally power-scaled, and is added at 49 to the bit sequence of the DPCH.

Thus, on the transmission side, the present invention adds a new downlink signal sequence to the existing DPCH sequence. The new signal sequence is added to the existing sequence with an optional relative power scaling. The new signal sequence is obtained by bit-level spreading a downlink message such as an ACK/NACK message with a spreading sequence having good cross-correlation and auto-correlation properties 45. The combined signal is subsequently processed similar to the conventional DPCH signal by the base station transmission system. To illustrate the principles of the invention, an ACK/NACK message is utilized in the following description as exemplary new downlink information. It should be understood, however, that the invention may similarly incorporate other simple downlink information.

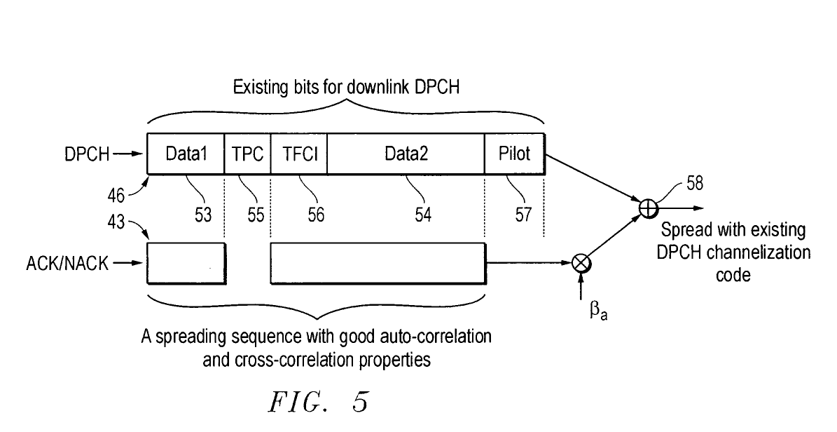

FIG. 5 is an illustration of a slot format showing a generic bit sequence format for a general downlink DPCH 46 to which an ACK/NACK signal 43, spread by a spreading sequence having good auto-correlation and cross-correlation properties, has been added. In the top portion of FIG. 5, it can be observed that the bit sequence format for the general downlink DPCH sequence contains two data parts 53 and 54 for the Dedicated Physical Data Channel (DPDCH) and three parts for the Dedicated Physical Control Channel (DPCCH), namely, a Transmit Power Command (TPC) 55, a Transport Format Combination Indicator (TFCI) 56, and a pilot sequence 57. This bit sequence is subsequently spread by an existing DPCH channelization code to the chip level at 58, and is then transmitted in the downlink to the target UE.

The ACK/NACK signal 43 is bit-level spread with a spreading code having good auto-correlation and also good cross-correlation to the DPCH. As noted above, the spreading sequence has a bit rate equal to the bit rate of the DPCH. For illustration purposes, FIG. 5 illustrates that the new downlink signal is spread within a single time slot (i.e., 0.667 ms). In an alternative embodiment, the messages are spread across several slots, to achieve better performance. Preferably, the spread ACK/NACK signal is placed so that it does not overlap important bits in the DPCH such as the TPC bits 55 or the Pilot bits 57. Optionally, however, the spread signal may overlap the TCP or Pilot bits when transmitting to UEs that utilize advanced/enhanced receiver algorithms. This embodiment may require the target UE to employ more sophisticated signal processing algorithms on the receiver end. For example, the least-square (LS) channel estimation algorithm may be utilized to improve the performance of channel estimation when the pilot bits are overlapped. If the TPC bits are overlapped, a joint detection algorithm may be utilized for both the TPC and the new spread sequence.

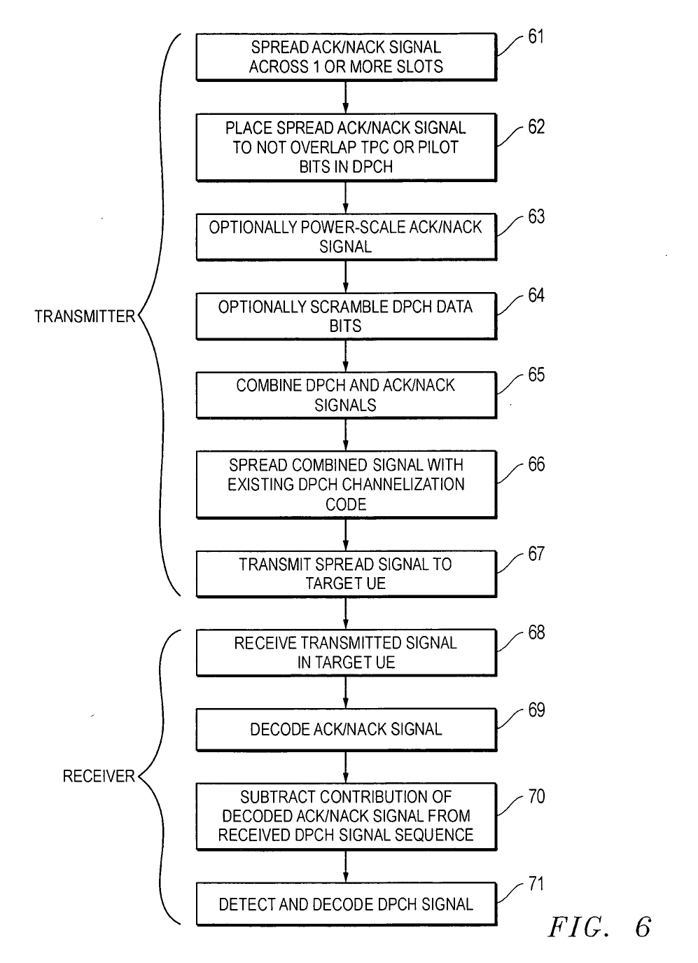

FIG. 6 is a flow chart illustrating the steps of the preferred embodiment of the method of the present invention. Steps 61-67 are performed by the base station or Node B. At step 61, the ACK/NACK signal 43 is spread across one or more time slots with a spreading code having good cross-correlation properties. At step 62, the spread ACK/NACK signal is placed so that it does not overlap the TPC bits 55 or pilot bits 57 in the DPCH signal 46. At step 63, the ACK/NACK signal is optionally power-scaled, and at step 64, the data bits in the DPCH are optionally scrambled. The DPCH data bits may be scrambled to reduce interference with the new signaling channel due to any sequence of the DPCH that happens to have high cross-correlations with the bit-level spreading sequence of the new signaling channel. The DPCH signal and ACK/NACK signal are then combined at step 65 to form a combined signal, and at step 66 the combined signal is spread with the existing DPCH channelization code. Since the ACK/NACK signal is carried by the existing channelization code for the existing downlink DPCH, no additional channelization code resources need to be allocated. The spread signal is then transmitted to the target UE at step 67.

Steps 68-71 are performed by the target UE. With proper transmission power control, the ACK/NACK signal 43 is received at step 68 by the target UE with the required quality (for example, with less than one percent detection error rate). The performance of the existing DPCH 46 is, likewise, not adversely affected by adding the spread ACK/NACK signal. In the preferred embodiment, the UE first decodes the new downlink signal (e.g., ACK/NACK signal 52) at step 69. After decoding the spread ACK/NACK information, the receiver determines the effects that the ACK/NACK signal had on the DPCH signal sequence, and subtracts the contribution of the decoded signal from the received DPCH signal sequence at step 70. Implementation of this subtraction is straightforward because it only involves operations at the bit-level (after channelization code de-spreading). After subtraction, the detection and decoding of the DPCH signal proceed as in a conventional receiver at step 71. Since the ACK/NACK signal is carried by the existing channelization code 42 for the existing DPCH, the receiving UE is not required to demodulate additional codes. The UE can respond to power commands and estimate the channels as in a conventional system because the TPC and pilot fields are not modified. Since the information rates of the downlink messages are very low, the optimal maximum-likelihood detection algorithms can be easily implemented.

Exemplary performance calculations indicate that the present invention provides significant gains in performance while avoiding the peak-power and interference problems associated with prior art methodologies. For example, an existing DPCH uses a spreading factor (SF) of 128, and thus allocates 28 bits for data, 2 bits for the TPC, 2 bits for the TFCI, and 8 bits for the pilot sequence. If it is assumed that an ACK/NACK signal is spread with a sequence of 28×3=84 bits (i.e., spread across 3 slots for 2 ms), it can be calculated that the ACK/NACK signal has 19 dB of processing gain over the DPCH. Note that the error rate of the TPC is targeted at four percent, and the new ACK/NACK signal has 16 dB of processing gain over the TPC.

As will be recognized by those skilled in the art, the innovative concepts described in the present application can be modified and varied over a wide range of applications. Accordingly, the scope of patented subject matter should not be limited to any of the specific exemplary teachings discussed above, but is instead defined by the following claims.

What is claimed is:

1. A method of transmitting a downlink signal from a base station to a user equipment (UE) terminal in a radio telecommunication system, said method comprising the steps of:
spreading the downlink signal across at least one time slot;
combining the spread downlink signal with a dedicated physical channel (DPCH) signal to form a combined signal;
spreading the combined signal using a channelization code already assigned to the DPCH; and
transmitting the spread combined signal to the UE terminal.

2. The method of claim 1, wherein the step of spreading the downlink signal across at least one time slot includes bit-level spreading the downlink signal utilizing a spreading sequence having good auto-correlation and cross-correlation properties with the DPCH signal.

3. The method of claim 1, wherein the combining step includes placing the spread downlink signal in relation to the DPCH signal such that the downlink signal does not overlap important bits in the DPCH signal.

4. The method of claim 3, wherein the step of placing the spread downlink signal in relation to the DPCH signal such that the downlink signal does not overlap important bits in the DPCH signal includes placing the spread downlink signal where it does not overlap transmit power command (TPC) bits or pilot sequence bits in the DPCH signal.

5. The method of claim 1, further comprising, prior to combining the spread downlink signal with the DPCH signal, the step of power-scaling the downlink signal.

6. The method of claim 1, further comprising, prior to combining the spread downlink signal with the DPCH signal, the step of scrambling data bits in the DPCH signal.

7. A method of transmitting a downlink signal on a dedicated physical channel (DPCH) from a base station to a user equipment (UE) terminal in a radio telecommunication system, said method comprising the steps of:
spreading the downlink signal across at least one time slot utilizing a spreading sequence having good cross-correlation properties with the DPCH;
combining the spread downlink signal with a DPCH signal to form a combined signal, wherein the downlink signal does not overlap important bits in the DPCH signal;
spreading the combined signal utilizing a channelization code of the DPCH; and
transmitting the spread combined signal to the UE terminal.

8. The method of claim 7, wherein the step of spreading the downlink signal also includes spreading the downlink signal across at least one time slot utilizing a spreading sequence having good auto-correlation properties with the DPCH.

9. The method of claim 8, further comprising, prior to combining the spread downlink signal with the DPCH signal, the step of power-scaling the downlink signal.

10. The method of claim 8, further comprising, prior to combining the spread downlink signal with the DPCH signal, the step of scrambling data bits in the DPCH signal.

11. A method of transferring information on a dedicated physical channel (DPCH) from a base station to a user equipment (UE) terminal in a radio telecommunication system, said method comprising the steps of:
spreading a downlink signal containing the information across at least one time slot;
combining the spread downlink signal with a DPCH signal to form a combined signal;
spreading the combined signal utilizing a channelization code of the DPCH;
transmitting the spread combined signal to the UE terminal;
separately decoding the downlink signal by the UE terminal to extract the information;
determining effects that the downlink signal had on the received DPCH signal;
subtracting the effects of the downlink signal from the DPCH signal; and
decoding the DPCH signal.

12. The method of claim 11, wherein the step of spreading the downlink signal across at least one time slot includes bit-level spreading the downlink signal utilizing a spreading sequence having good auto-correlation and cross-correlation properties with the DPCH signal.

13. The method of claim 12, wherein the combining step includes placing the spread downlink signal in relation to the DPCH signal such that the downlink signal does not overlap important bits in the DPCH signal.

14. The method of claim 13, wherein the step of placing the spread downlink signal in relation to the DPCH signal such that the downlink signal does not overlap important bits in the DPCH signal includes placing the spread downlink signal where it does not overlap transmit power command (TPC) bits or pilot sequence bits in the DPCH signal.

15. The method of claim 13, further comprising, prior to combining the spread downlink signal with the DPCH signal, the step of power-scaling the downlink signal.

16. The method of claim 15, further comprising, prior to combining the spread downlink signal with the DPCH signal, the step of scrambling data bits in the DPCH signal.

17. An apparatus in a base station in a radio telecommunication network, said apparatus transferring information on a dedicated physical channel (DPCH) from the base station to a user equipment (UE) terminal, said apparatus comprising:
means for spreading the downlink signal across at least one time slot;
multiplexing means for combining the spread downlink signal with a DPCH signal to form a combined signal;
means for spreading the combined signal utilizing a channelization code of the DPCH; and
transmission means for transmitting the spread combined signal to the UE terminal.

18. The apparatus of claim 17, wherein the means for spreading the downlink signal bit-level spreads the downlink signal utilizing a spreading sequence having good auto-correlation and cross-correlation properties with the DPCH signal.

19. The apparatus of claim 17, wherein the multiplexing means places the spread downlink signal in relation to the DPCH signal such that the downlink signal does not overlap transmit power command (TPC) bits or pilot sequence bits in the DPCH signal.

20. The apparatus of claim 17, further comprising means for power-scaling the downlink signal prior to combining the downlink signal with the DPCH signal by the multiplexing means.

21. The apparatus of claim 17, further comprising means for scrambling data bits in the DPCH signal prior to combining the downlink signal with the DPCH signal by the multiplexing means.

22. An apparatus in a user equipment (UE) terminal in a radio telecommunication network, said apparatus receiving and decoding information contained in a downlink signal transmitted on a dedicated physical channel (DPCH) from a base station, said apparatus comprising:
means for receiving a spread combined signal transmitted from the base station on the DPCH, said spread combined signal including a spread downlink signal combined with a DPCH signal;
means for separately decoding the spread downlink signal to extract the information;
means for determining effects that the spread downlink signal had on the received DPCH signal, and for subtracting the effects of the spread downlink signal from the DPCH signal; and
means for decoding the DPCH signal.

23. The apparatus of claim 22, wherein the means for separately decoding the spread downlink signal includes means for correlating the received DPCH signal with a bit-level spreading sequence for the downlink signal.

24. The apparatus of claim 23, wherein the means for determining effects that the spread downlink signal had on the received DPCH signal includes means for re-spreading the detected downlink signal with the bit-level spreading sequence.

25. The apparatus of claim 24, wherein the re-spread signal is further filtered by an estimated effective channel response.

26. A system in a radio telecommunication network for transferring information on a dedicated physical channel (DPCH) from a base station to a user equipment (UE) terminal, said system comprising:
means within the base station for spreading the downlink signal across at least one time slot utilizing a spreading sequence having good auto-correlation and cross-correlation properties with the DPCH signal;
multiplexing means within the base station for combining the spread downlink signal with a DPCH signal to form a combined signal;
means within the base station for spreading the combined signal utilizing a channelization code of the DPCH;
transmission means within the base station for transmitting the spread combined signal to the UE terminal;
means within the UE terminal for receiving the spread combined signal;
means within the UE terminal for separately decoding the spread downlink signal to extract the information;
means within the UE terminal for determining effects that the spread downlink signal had on the received DPCH signal, and for subtracting the effects of the spread downlink signal from the DPCH signal; and
means within the UE terminal for decoding the DPCH signal.
